(19) United States
(12) Patent Application Publication
(10) Pub. No.: US 2026/0236278 A1
(43) Pub. Date: Aug. 13, 2026

(54) Systems and Methods for Dynamically Deploying and Activating Third-Party Artificial Intelligence Agents with Dynamic Content Adaptation on First-Party Controlled Interfaces

(71) Applicant: MARKETINGSOLUTIONS.AI, LLC, Chicago, IL (US)

(72) Inventor: Christopher Michael Corson, Chicago, IL (US)

(73) Assignee: MARKETINGSOLUTIONS.AI, LLC, Chicago, IL (US)

(21) Appl. No.: 19/097,311

(22) Filed: Apr. 1, 2025

Related U.S. Application Data
(60) Provisional application No. 63/758,208, filed on Feb. 13, 2025.

(51) Int. Cl. G06F 9/451; G06F 3/0481; G06F 3/0484; G06T 11/60

(52) U.S. Cl. CPC G06F 9/453; G06F 3/0481; G06F 3/0484; G06T 11/60; G06T 2200/24

(57) ABSTRACT

A distributed artificial intelligence (AI) provisioning system and associated methods are provided to deploy and activate third-party AI agents with dynamic content adaptation on different first-party controlled interfaces. The system receives a request that indicates a user accessing a first-party controlled interface, and selects a particular third-party AI agent that is associated with content, services, or offerings that are different from and related to content, services, or offerings on the first-party controlled interface. The system embeds and activates the particular third-party AI agent on the first-party controlled interface to present an independent interactive interface on the first-party controlled interface with dynamically generated content that is customized based on the different but related content, services, or offerings and user interactions with one or more of the interactive interface and the first-party controlled interface.

### CLAIM OF BENEFIT TO RELATED APPLICATIONS

This application claims the benefit of U.S. provisional application 63/758,208 with the title “System and Method for Deploying Dormant AI Advertising Agents on Third-Party Platforms with Trigger-Based Activation, Real-Time Bidding, and Multi-Agent Engagement”, filed Feb. 13, 2025. The contents of application 63/758,208 are hereby incorporated by reference.

### BACKGROUND

The rapid evolution of artificial intelligence (AI) has enabled businesses to deploy AI agents (e.g., chatbots, customized applications, customized services, customized application programming interfaces (APIs), etc.) on their user-facing interfaces (e.g., network-accessible websites, applications, APIs, or services) to assist users in real-time. The AI agents provide dynamic content in addition to the existing content of the interface and/or advertising presented on the interface. The AI agents may resolve user issues, provide supplemental services, answer questions, and/or provide relevant information that the user seeks without the user having to navigate the interface or contact business representatives via telephone calls, emails, or other means.

The AI agents are trained specifically for the content or services of the business represented by the user-facing interface. In other words, a website offered by a particular business may provide an AI agent that can answer questions or resolve issues related to the offerings of the particular business but not offerings of other businesses or other third-party sites. The AI agents are therefore limited to supporting the business or first-party content and services with which they are deployed. However, users often require access to complementary or unrelated services, necessitating navigation to other interfaces. This redirection not only disrupts the user journey but also results in lost monetization opportunities for the first-party interface. For instance, a rental car website or application may activate an AI agent that assists users with booking a rental car from the rental car company represented by the website or application. However, if a user wishes to book a hotel room, the user cannot use the AI agent and must navigate away from the rental car website or application to a hotel booking website or must open a different hotel booking application. Consequently, a first-party platform (e.g., the rental car website or application) may lose a monetization opportunity when a user navigates to another third-party platform. The lost monetization opportunity may include revenue from the user clicking on advertising presented on the first-party platform, the user purchasing other services or offerings from the first-party platform, and/or the first-party platform receiving a referral fee for connecting the user to a specific third-party platform.

### BRIEF DESCRIPTION OF THE DRAWINGS

FIG. 1 illustrates an example of the dynamic deployment and activation of third-party artificial intelligence (AI) agents on different first-party controlled interfaces in accordance with some embodiments presented herein.

FIG. 2 illustrates an example architecture for a distributed AI provisioning system in accordance with some embodiments presented herein.

FIG. 3 presents a process for dynamically selecting third-party AI agents to embed on a first-party controlled interface through a real-time bidding platform in accordance with some embodiments presented herein.

FIG. 4 illustrates an example of training a third-party AI agent for different first-party controlled interfaces in accordance with some embodiments presented herein.

FIG. 5 illustrates an example of performing a third-party AI agent handoff on a first-party controlled interface in accordance with some embodiments presented herein.

FIG. 6 illustrates an example of the distributed AI provisioning system running in the background of a first-party controlled interface in accordance with some embodiments presented herein.

FIG. 7 illustrates an example of integrating the distributed AI provisioning system as part of a first-party controlled interface via a concierge AI agent in accordance with some embodiments presented herein.

FIG. 8 illustrates an example of integrating the distributed AI provisioning system with a kiosk in accordance with some embodiments presented herein.

FIG. 9 presents a process for providing third-party AI agents as search results to a user query in accordance with some embodiments presented herein.

FIG. 10 illustrates example components of one or more devices, according to one or more embodiments described herein.

### DETAILED DESCRIPTION OF PREFERRED EMBODIMENTS

The following detailed description refers to the accompanying drawings. The same reference numbers in different drawings may identify the same or similar elements.

Disclosed are systems and associated methods for dynamically deploying and activating third-party artificial intelligent (AI) agents with dynamic content adaptation on different first-party controlled interfaces. In some embodiments, a distributed AI provisioning system performs and/or controls the dynamic deployment and activation of the third-party AI agents on the first-party controlled interfaces. The first-party controlled interfaces may include websites, downloadable applications that execute on user devices, interactive environments, spatial computing experiences (e.g., virtual reality, mixed reality, augmented reality, and/or other enhanced reality experiences), and/or other content offered or controlled by a first-party. The third-party AI agents may include chatbots, customized applications, customized services, customized application programming interfaces (APIs), and/or other content offered or controlled by a third-party and that are embedded and presented on the first-party controlled interface in order to provide content, services, or offerings that are different from and related to content, services, or offerings on the first-party controlled interface. In some embodiments, the third-party AI agents may include agents that operate without direct user interaction (e.g., via background intelligence), multi-modal agents hat process various input types beyond text and/or speech, predictive or proactive agents that anticipate user needs, and/or edge-deployed autonomous agents with varying degrees of connectivity.

The distributed AI provisioning system analyzes a first-party controlled interface and/or tracks user activity on the first-party controlled interface or on other interfaces that the user visited prior to the first-party controlled interface. The distributed AI provisioning system selects a particular third-party AI agent that is relevant for the first-party controlled interface and/or for the user based on the analysis. For instance, the distributed AI provisioning system selects a third-party AI agent that provides content or services that are complimentary to but different than those offered on the first-party controlled interface, or selects a third-party AI agent that that fulfills the user's external intent within the first-party interface (e.g., supplies the user with external content or services that the user seeks from the first-party controlled interface) so that the user remains on the first-party controlled interface and does not have to navigate away from the first-party controlled interface for the external content or services. The distributed AI provisioning system embeds the selected third-party AI agent on the first-party controlled interface in order to present different offerings of the third-party through the third-party AI agent on the first-party controlled interface.

The dynamic selection of the third-party AI agent introduces interface efficiencies by allowing the user to access one first-party controlled interface, search for certain content or services on that first-party controlled interface, and receive the certain content or services even when those content or services are not part of the first-party controlled interface. Specifically, the interface efficiencies include providing the desired content or services via the dynamically selected third-party AI agent that is presented on the first-party controlled interface without the user having to repeat the search or query on a search engine or another first-party controlled interface, manually identify the relevant different first-party controlled interface, and/or navigate away from the original first-party controlled interface.

To seamlessly embed the different third-party AI agents within different first-party controlled interfaces and/or provide a seamless experience to the external content and services of the third-party AI agents from the first-party controlled interfaces, the distributed AI provisioning system may train the selected third-party AI agent to mirror the tone, content, language, style, and/or other characteristics of the first-party controlled interface prior to activating the third-party AI agent on the first-party controlled interface. For instance, if the first-party controlled interface is for certain luxury items, the distributed AI provisioning system may train the third-party AI agent to interact with users of the first-party controlled interface with a formal tone, with high-end offerings of the third-party, and with language that expresses the quality of the high-end offerings, whereas if the first-party controlled interface is for certain discounted items, the distributed AI provisioning system may train the third-party AI agent to interact with the users of the first-party controlled interface with an informal tone, with discounted or promotional items, and/or with language that expresses the deals or savings associated with the discounted or promotional items. The training may further include the distributed AI provisioning system reskining or changing the visual characteristics of the third-party AI agents to match or to seamlessly integrate with the visual characteristics of the first-party controlled interface. The dynamic training of the third-party AI agents by the distributed AI provisioning systems reduces the appearance of the users being redirected away from a first-party controlled interface and/or may increase the likelihood of the user completing a transaction with the third-party AI agent if the user has a certain loyalty to or level-of-trust with the first-party controlled interface by presenting the third-party AI agents with a seamless and/or tighter integration with the first-party controlled interface.

In some embodiments, the distributed AI provisioning system creates new monetization opportunities for the first-party controlled interface through the dynamic deployment and activation of different third-party AI agents on the first-party controlled interface. The new monetization opportunities includes referral fees that the selected third-party AI agents provide to the first-party controlled interface for access to the users of the first-party controlled interface and/or retaining the users on the first-party controlled interface such that the users may be presented with additional advertisements that the first-party controlled interface is compensated for or increases the likelihood that the users will purchase services from the first-party controlled interface.

The new monetization opportunities may include the distributed AI provisioning system implementing a real-time bidding platform as part of the dynamic AI agent selection and activation. Different third-party AI agents that provide competing services (e.g., AI agents of different rental car companies) may place bids on the real-time bidding platform for selection and activation on relevant first-party controlled-interfaces or for targeted users that are identified on a first-party controlled-interface. In some such embodiments, the distributed AI provisioning system may track users that navigate to a first-party controlled-interface, may provide data and/or statistics associated with the tracked users on the real-time bidding platform, and may also provide data about the first-party controller interface to assist the third-parties in determining the likelihood of monetizing the user prior to placing the bids on the real-time bidding platform for presentation of their AI agents to the user on the first-party controlled interface.

To increase the monetization opportunities, the distributed AI provisioning system may configure the third-party AI agents to perform handoffs to other third-party AI agents on a first-party controlled interface. For instance, a first third-party AI agent may be presented on the first-party controlled interface to assist a user with renting a car from a first rental car company. Once the rental is confirmed, the first third-party AI agent may handoff the user to a second third-party AI agent that assists the user with booking a hotel room with a second hotel company. The first third-party AI agent may shutdown or terminate on the first-party controlled interface, and the second third-party AI agent may activate in place of the first third-party AI agent on the first-party controlled interface. The AI agent handoffs retain the user on the first-party controlled interface, expand the scope of services or offerings that the user may access directly from the first-party controlled interface, and increases the monetization opportunities for the first-party controlled interface. For instance, the first-party controlled interface may receive a payment for every third-party AI agent that is presented on their interface or for every transaction that is completed through a third-party AI agent that is presented on their interface. In some embodiments, the revenue generated for the third-party AI agent embedding and presentation on the first-party controlled interface may be shared among multiple entities, including the first-party controlled interface, the third-party AI agent creator, and the distributed AI provisioning platform. The revenue-sharing model may be predefined by contract, dynamically negotiated via platform logic, or determined via smart contracts or real-time bidding structures

Accordingly, the distributed AI provisioning system provides technical solutions to technical problems in the fields of AI, graphical user interface, e-commerce, and digital advertising. The technical solutions include retaining users on a first-party controlled interface through the dynamic selection of the third-party AI agents. The technical solutions further include allowing businesses or brands to directly communicate with users without having the users contact the businesses or brands directly through their own websites, applications, telephone numbers, etc. The distributed AI provisioning system provides the means by which the businesses or brands may communicate with users through various interfaces that are controlled by other first-parties. The technical solutions further include creating new monetization mechanisms for the first-party controlled interfaces that differ from traditional online advertising solutions.

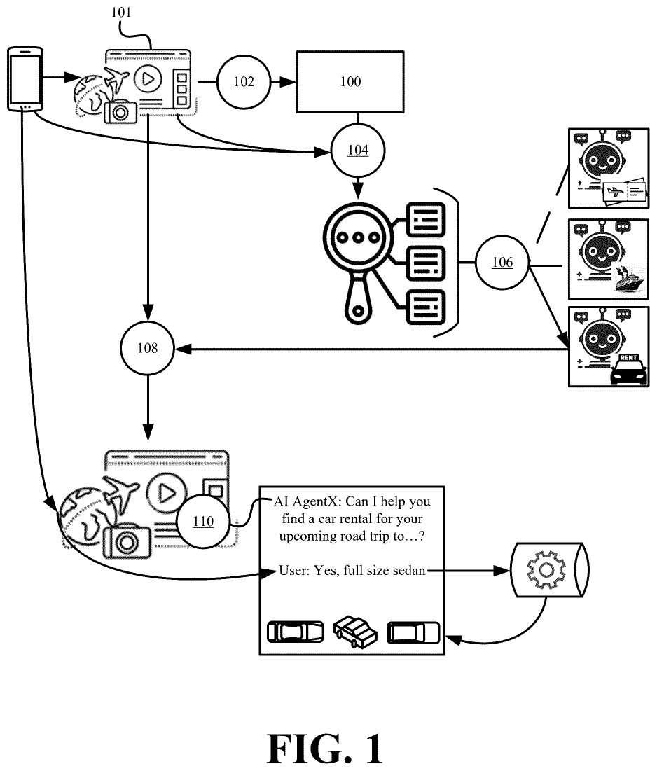

FIG. 1 illustrates an example of the dynamic deployment and activation of third-party AI agents on different first-party controlled interfaces in accordance with some embodiments presented herein. Distributed AI provisioning system 100 receives (at 102) a request for activating a third-party AI agent on first-party controlled interface 101. First-party controlled interface 101 issues the request in response to a user device accessing first-party controlled interface 101. More specifically, the user device may request first-party controlled interface 101 from a web server, and the request may activate or execute an advertising tag, an application programming interface (API) call, JavaScript, or other code associated with first-party controlled interface 101 for requesting (at 102) the third-party AI agent from distributed AI provisioning system 100.

The request may include information about the visiting user and/or first-party controlled interface 101. For instance, the user information may include a network address (e.g., Internet Protocol (IP) address) of the user device, a cookie, or other token for search queries, redirect links, or other tracked activity associated with the user. The information about first-party controlled interface 101 may include the Uniform Resource Locator (URL) or IP address of first-party controlled interface 101 and/or identifiers regarding the content of first-party controlled interface 101 (e.g., travel site, banking site, streaming service, etc.).

Distributed AI provisioning system 100 analyzes (at 104) the information provided with the request, content that is presented on first-party controlled interface 101, and/or user activity that is performed on first-party controlled interface 101 and/or performed prior to the user device arriving at first-party controlled interface 101. For instance, first-party controlled interface 101 may include code that allows distributed AI provisioning system 100 to monitor the user activity on first-party controlled interface 101. The user activity may include search terms entered by the user, keywords, clicks or selections of links or content on first-party controlled interface 101, other interactions that the user has with first-party controlled interface 101, and/or inputs to first-party controlled interface 101 that the user provides. Distributed AI provisioning system 100 may access the user activity that is performed prior to the user device arriving at first-party controlled interface 101 via cookies, tracking tokens, browser history, universal identifiers, browser fingerprinting, and/or other tracking tools or techniques.

Distributed AI provisioning system 100 selects (at 106) a third-party AI agent that is relevant for one or more of the content presented on first-party controlled interface 101 and/or the user based on the analysis. For example, first-party controlled interface 101 may be a travel blog site or review site for the best road trips. Distributed AI provisioning system 100 may select (at 106) a third-party AI agent of a rental car company that the user may directly interact with to rent a vehicle for their road trip. As another example, first-party controlled interface 101 may be a search engine in which the user queries for best beach vacations. Distributed AI provisioning system 100 may select (at 106) a third-party AI agent of an airline company that flies to one or more of the destinations listed in the search engine results.

The selection (at 106) of the third-party AI agent is performed by matching keywords, metadata, and/or identifiers that are associated with first-party controlled interface 101 and/or the visiting user to keywords, metadata, and/or identifiers that are associated with different third-party AI agents available to distributed AI provisioning system 100. In some embodiments, distributed AI provisioning system 100 downloads a copy of first-party controlled interface 101 and/or the content (e.g., text, images, video, etc.) from first-party controlled interface 101, classifies the downloaded content, and selects (at 106) a third-party AI agent with a similar or related classification as the content found on first-party controlled interface 101. In some embodiments, distributed AI provisioning system 100 tracks the user activity performed on first-party controlled interface 101 and/or before the user device arrives at first-party controlled interface 101, determines the user's interests or preferences based on the user activity, and selects (at 106) a third-party AI agent offering services related to the user's interests or preferences.

Distributed AI provisioning system 100 embeds (at 108) the selected (at 106) third-party AI agent on first-party controlled interface 101. Distributed AI provisioning system 100 may embed (at 108) the third-party AI agent on first-party controlled interface 101 as a JavaScript code snippet, as an iFrame, using a software development kit (SDK) or API of first-party controlled interface 101, or as other code that executes in conjunction with the code for first-party controlled interface 101.

The embedded (at 108) third-party AI agent activates (at 110) on first-party controlled interface 101. In some embodiments, activating (at 110) third-party AI agent includes presenting a window or dialog box within first-party controlled interface 101. The activated (at 110) third-party AI agent may engage the user as a chatbot that asks the user if they are interested in content or services that are offered by the third-party entity responsible for the third-party AI agent and that are not offered by first-party controlled interface 101 or content or services that may be of interest to the user based on the tracked user activity on first-party controlled interface 101 and/or that supplement the content or services found on first-party controlled interface 101. The user may interact with the activated (at 110) third-party AI agent to ask questions about content not found on first-party controlled interface 101 or to access services that are not offered by first-party controlled interface 101.

In some embodiments, distributed AI provisioning system 100 or first-party controlled interface 101 prompts the user for consent before activating the dynamically selected third-party AI agent. Consent may be collected via a pop-up dialog, banner, or persistent toggle, and may include acceptance of third-party terms or data usage disclosure. The consent may be carried over when handing off between different third-party AI agents or when the user accesses different first-party controlled interfaces 101.

In some embodiments, the third-party AI agent is a multi-model AI agent that the user may interact with using textual inputs or speech. For instance, the user may verbally interact with the third-party AI agent using voice commands and the third-party AI agent may answer with machine-generated speech. In some such embodiments, deep-fake technology may be used to generate the third-party AI agent in the form a human representative that verbally interacts with the user based on textual or verbal inputs from the user.

In some embodiments, the user interactions with the third-party AI agent bypass first-party controlled interface 101 and pass directly to an API, back-end, or executable services of the third-party that created the third-party AI agent. For instance, first-party controlled interface 101 may include a travel blog site and the activated (at 110) third-party AI agent may be a chatbot with which the user may rent a car from an unrelated car rental company. The user input to the third-party AI agent does not pass to the travel blog site back-end and is passed over a data network to a server of the car rental company. The third-party AI agent may communicate with the server to obtain rental car availability information, pricing, and/or to reserve a car at a specific location.

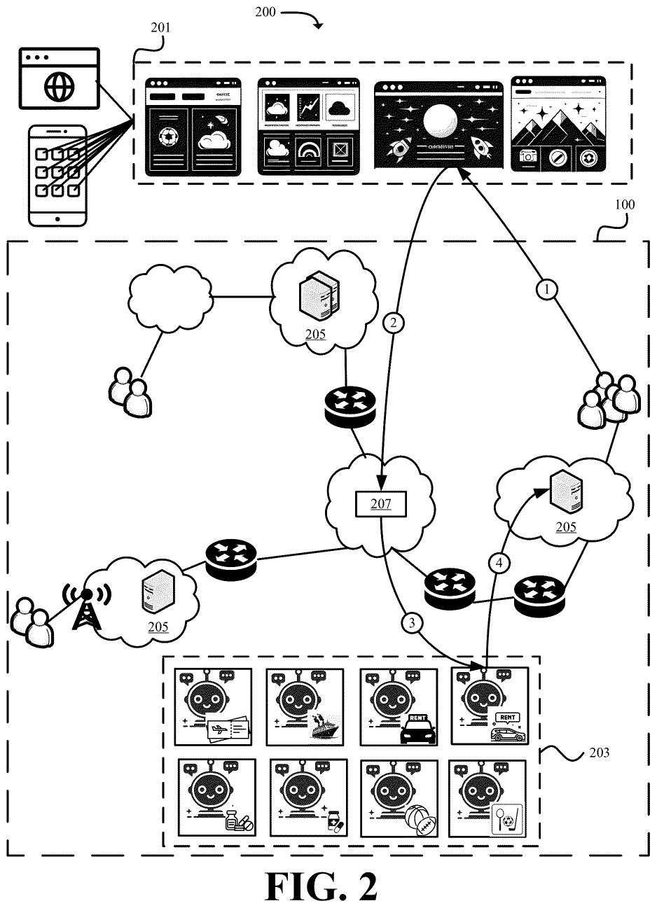

FIG. 2 illustrates an example architecture 200 for distributed AI provisioning system 100 in accordance with some embodiments presented herein. Architecture 200 includes first-party controlled interfaces 201, third-party AI agents 203, cloud or edge computing resources 205, and controller 207.

First-party controlled interfaces 201 are websites, applications, interactive environments, spatial computing experiences, and/or other online (e.g., Internet) accessible or downloadable content that are created, managed, and/or controlled by a first set of entities (e.g., first-parties). First-party controlled interfaces 201 provide access to content, services, and/or other offerings of the first set of entities.

Third-party AI agents 203 are chatbots or microservices that are created, managed, and/or controlled by a different second set of entities (e.g., third-parties). Third-party AI agents 203 are accessible from a website, application, interactive environment, spatial computing experience, and/or other online accessible or downloadable content of the second set of entities or from first-party controlled interfaces 201 when dynamically integrated into first-party controlled interfaces 201 by distributed AI provisioning system 100. In other words, users cannot directly access third-party AI agents 203 because third-party AI agents 203 are not standalone websites, applications, interactive environments, spatial computing experiences, and/or online accessible or downloadable content. In some embodiments, third-party AI agents 203 are implemented as containers (e.g., Docker, Kubernetes, etc.), virtual machines, scripts, executable binaries, or other code.

Third-party AI agents 203 provide access to content, services, and/or other offerings of the second set of entities. Third-party AI agents 203 differ from first-party controlled interfaces 201 in that they create dynamic content rather than present the same static content to all users. Moreover, third-party AI agents 203 use natural language processing (NLP) to interact with users. In particular, users may speak to or provide textual inputs to interact with third-party AI agents 203 and third-party AI agents 203 may reply with machine-generated dialog or text in combination with any content, executed services, and/or other offerings of the second set of entities.

Each third-party AI agent 203 may include a neural network or machine learning model that is trained with the content, services, and/or other offerings from one of the second set of entities. The neural network or machine learning model is a generative model that generates content in order to respond to queries directed to trained dataset of content, services, and/or other offerings, determine user interest in the content, services, and/or other offerings, and/or assist users in accessing or acquiring the content, services, and/or other offerings.

The neural network or machine learning model may also be trained with different human behaviors, principles, and/or mannerisms. This training adapts the generated content to empathize with users for better engagement. Stated differently, the neural network or machine learning model is trained to modify its output according to the sentiment, tone, word choice, and/or other characteristics of the user input. The modified output appeals to user interests and creates a conversational flow or dialog that mimics user-to-user interactions or best practices used by human representatives to engage customers and/or progress users through the content, services, and/or other offerings.

In some embodiments, each third-party AI agent 203 may continuously adapt its responses during a user session based on one or more interaction signals. These signals may include input content, behavioral cues (e.g., scrolling, clicks, hesitations), inferred sentiment or tone, or contextual metadata provided by first-party controlled interface 201. Distributed AI provisioning system 100 may refine or restructure agent 203 outputs to align with detected user preferences, conversation progression, or predictive engagement scoring. These modifications may affect tone, format, content hierarchy, or call-to-action priority. Such personalization mechanisms may also be applied across audio-first, renderless, or spatial interfaces, enabling session-aware adaptation in emerging user environments.

In some embodiments, distributed AI provisioning system 100 stores session data associated with individual users and interactions with specific third-party AI agents 203, including prior inputs, preferences, or interaction history. When the same user re-engages with a particular third-party AI agent 203, whether on the same or a different first-party controlled interface 201, distributed AI provisioning system 100 may retrieve the prior session data to restore the state of the previous interaction with the particular third-party AI agent 203, providing a sense of continuity and personalization across visits or devices.

Third-party AI agents 203 may be hosted and/or run from cloud or edge computing resources 205. Cloud or edge computing resources 205 include machines or devices with processor, memory, storage, network, and/or other hardware resources that are dynamically allocated to execute one or more third-party AI agents 203 by distributed AI provisioning system 100. Accordingly, first-party controlled interface 201 may run on hardware or devices of the first-party entity while third-party AI agents 203 run on separate hardware or devices of cloud or edge computing resources 205. In some other embodiments, third-party AI agents 203 may download content or a model subset during activation and continue operating in a limited capacity when disconnected from a network. Such offline operation may include basic interaction, cached responses, or decision trees sufficient to handle anticipated use cases.

In some embodiments, various third-parties register with distributed AI provisioning system 100 to enter their third-party AI agents 203 into the system and make them accessible for activation on different first-party controlled interfaces 201. In some such embodiments, third-party AI agents 203 are centrally stored at one or more cloud sites 205 where the third-parties retain control over their third-party AI agents 203. For instance, the third-parties may update their third-party AI agents 203 as needed on the one or more cloud sites 205. In some such embodiments, distributed AI provisioning system 100 may deploy the third-party AI agents 203 from cloud sites 205 to one or more edge computing resources 205 where the third-party AI agents 203 may communicate with user devices and/or first-party controlled interface 201 with less latency. For instance, in response to a request for a third-party AI agent 203 from a particular first-party controlled interface 201, distributed AI provisioning system 100 selects the relevant third-party AI agent 203 for that particular first-party controlled interface 201 and deploys the selected third-party AI agent 203 to run from an edge computing resource 205 that is located closest in the data network to the particular first-party controlled interface 201 or the user device that connects to the particular first-party controlled interface 201 and that communicates with the selected third-party AI agent 203.

Controller 207 includes one or more devices or machines of distributed AI provisioning system 100 that receives the requests for third-party AI agents 203 from first-party controlled interfaces 201, that dynamically selects which third-party AI agent 203 to provide for which users on which first-party controlled interfaces 201, that deploys the selected third-party AI agents 203 to cloud or edge computing resources 205, and that activates the deployed third-party AI agents 203 to communicate and offer external content, services, or functionality to the users of first-party controlled interfaces 201.

Controller 207 may embed or insert third-party AI agents 203 on first-party controlled interfaces 201 using script injection, containerized application embedding, API-triggered rendering, or other mechanisms operable within the execution or rendering environment of first-party controlled interfaces 201. The various embedding and/or insertion techniques support placement of third-party AI agents 203 on different first-party controlled interfaces 201 including websites, mobile applications, kiosks, extended reality devices, and the like. Accordingly, the integration techniques used to embed third-party AI agent 203 within first-party controlled interfaces 201 is not limited to current technologies. Integration may occur via any mechanism operable within the execution environment of first-party controlled interface 203, including future interface rendering systems such as WebAssembly, spatial overlays, GPU-layer insertion, or virtualized interface rendering frameworks.

In some embodiments, distributed AI provisioning system 100 acts as a routing layer between users and third-party endpoints. Rather than embedding third-party AI agent 203 directly on first-party controlled interface 201, distributed AI provisioning system 100 may analyze contextual signals from the first-party controlled interface 201 or the user environment to determine which third-party AI agent 203 is most appropriate for the user query or interaction. These signals may include user search terms, keywords, topics, content groups, user inputs, device characteristics, geographic location, behavioral history, or application context. Distributed AI provisioning system 100 may then route the user query to the selected third-party AI agent 203 and present the resulting content or response in a format consistent with the user's current environment, without requiring direct embedding of third-party AI agent 203. In some embodiments, distributed AI provisioning system 100 selects between multiple candidate third-party AI agent 203 that are deemed contextually relevant. The selection may be based on criteria such as endpoint performance, user personalization profiles, content relevance, or bidding value. In other embodiments, distributed AI provisioning system 100 may coordinate routing across distributed agent networks in order to compose or fuse responses from multiple third-party AI agents 203.

Controller 207 is configured with a contextual classifier and/or user tracker. The contextual classifier and the user tracker are used to increase the relevance of the third-party AI agents 203 that are selected and activated for different users on the same or different third-party controlled interfaces 201.

The contextual classifier analyzes the content, services, or offerings of first-party controlled interfaces 201 to determine their relevance to specific topics (e.g., vacation, road trip, banking, stocks, jewelry, clothing, etc.). The analysis may include performing a semantic clustering or graphing of the content, and classifying the content based on semantic similarity of the content to a defined set of categories. In some embodiments, the contextual classifier performs the analysis as each request for a third-party AI agent 203 is received from a first-party controlled interface 201. In some other embodiments, the contextual analyzer is configured with a list of first-party controlled interfaces 201 that embed third-party AI agents 203 provided by distributed AI provisioning system 100, and the contextual analyzer periodically (e.g., daily, weekly, etc.) scans each first-party controlled interface 201 in the list to maintain an updated record of their relevance to the different topics.

The user tracker employs various automated tools and functionality to track user activity prior to landing on a first-party controlled interface 201 and/or while on the first-party controlled interface 201. For instance, the user tracking may use cookies, tracking tokens, universal identifiers, redirect links, query parameters, browser history, request headers, and/or other data to determine other sites that the user has visited. Moreover, the user tracking may uniquely identify the user or user device in order to obtain a user profile or Customer Relationship Management (CRM) data for the user's interests, preferences, past purchases, and/or browsing history. In some embodiments, the user tracker also runs on each first-party controlled interface 201. In some such embodiments, the user tracker monitors user clicks or selections, dwell time on specific content, search terms, keywords, topics, and/or other inputs to the first-party controlled interface 201. From the tracked user activity, the user tracker determines relevant topics, interests, and/or preferences of the user.

Controller 207 uses the outputs of the contextual classifier and the user tracker to dynamically select a third-party AI agent 203 that is relevant for a first-party controlled interface 201 and a user on that first-party controlled interface 201. Controller 207 allocates cloud or edge computing resources 205 to run each selected third-party AI agent 203 and embeds the selected third-party AI agent 203 into first-party controlled interface 201 using a JavaScript SDK, advertising server integration mechanisms that deploy the third-party AI agents 203 as interactive advertising units, iFrames, API calls, or other functionality that allows the selected third-party AI agent 203 to run independently but as part of first-party controlled interface 201.

In some embodiments, controller 207 runs a real-time bidding platform to select between different third-party AI agents 203 that may be of equal or similar relevance to a user and/or first-party controlled interface 201 being access by that user. The different third-party AI agents 203 may offer the same services from different competing entities or different services that address the same user interests. For instance, controller 207 may determine that a rental car AI agent is relevant for a particular first-party controlled interface 201. Controller 207 may have access to a set of third-party AI agents 203 from different rental car companies that are all relevant for the particular first-party controlled interface 201 and that can each be used to rent a car from a different rental car company. Accordingly, controller 207 may execute the real-time bidding platform to select a particular third-party AI agent 203 from the set of third-party AI agents 203 that bids the highest in order to be selected and embedded on the particular first-party controlled interface 201. The bid may include a monetary sum that the particular third-party AI agent 203 (e.g., the third-party entity that controls the particular third-party AI agent 203) provides to distributed AI provisioning system 100 and that distributed AI provisioning system 100 shares with the particular first-party controlled interface 201.

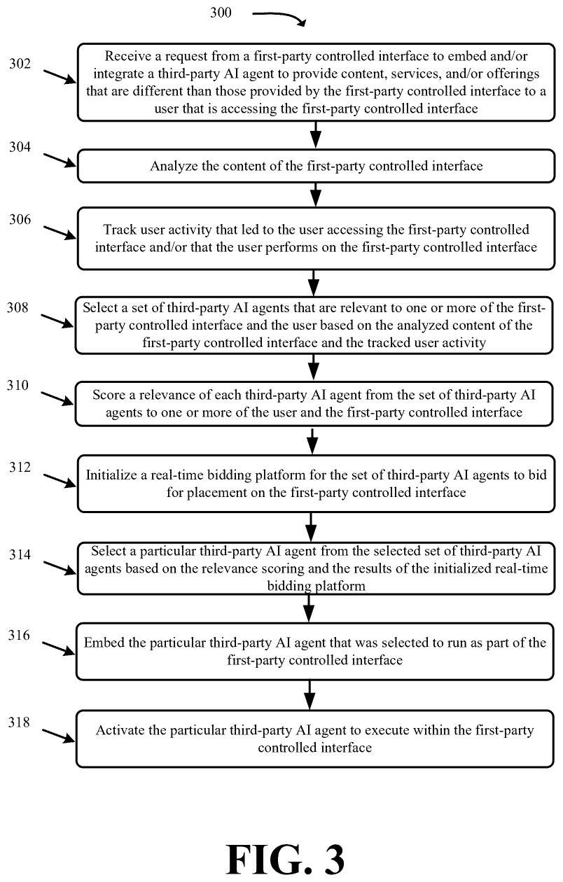

FIG. 3 presents a process 300 for dynamically selecting third-party AI agents to embed on a first-party controlled interface through a real-time bidding platform in accordance with some embodiments presented herein. Process 300 is implemented by distributed AI provisioning system 100, and more specifically, by controller 207 of distributed AI provisioning system 100.

Process 300 includes receiving (at 302) a request from a first-party controlled interface to embed and/or integrate a third-party AI agent to provide content, services, and/or offerings that are different than those provided by the first-party controlled interface to a user that is accessing the first-party controlled interface. In some embodiments, the request is triggered or sent in response to code that is executed on the first-party controlled interface when the first-party controlled interface is rendered and/or presented on the user device. For instance, the request may be issued in response to an advertising tag, link, HyperText Markup Language (HTML) attribute, JavaScript, or other code that is executed or called in the code of the first-party controlled interface. In some other embodiments, the request is triggered when a dormant service or AI agent that runs in the background on the first-party controlled interface detects certain conditions or events are met by the activity of the user accessing the first-party controlled interface.

Process 300 includes analyzing (at 304) the content of the first-party controlled interface. Distributed AI provisioning system 100 may download a copy of the first-party controlled interface or may run the contextual classifier on the first-party controlled interface that is presented to the user in order to obtain the first-party controlled interface content, and may classify the content based on a semantic matching of the content to different topics. In some embodiments, the contextual classifier may use an image processor or image recognition technique to classify the images or videos that are presented on the first-party controlled interface. For instance, a website that includes maps or images of attractions may be classified as a travel site.

Process 300 includes tracking (at 306) user activity that led to the user accessing the first-party controlled interface and/or that the user performs on the first-party controlled interface. Tracking (at 306) the user activity may include obtaining the user browser history, redirect links that brought the user to the first-party controlled interface, search engine inputs, and/or monitoring interactions that the user has with the first-party controlled interface. The interactions may include monitoring clicks or selections that the user makes, searches or inputs that the user enters into the first-party controlled interface, and/or dwell time of the user on different parts of the first-party controlled interface. Tracking (at 306) the user activity may include obtaining a universal identifier or other identifier that uniquely identifies the user or the user device, and retrieving a user profile based on the universal identifier or other identifier. The user profile may be populated with CRM data, interests or preferences of the user, user demographics (e.g., age, income, sex, location, etc.), and/or data about past browsing history or purchases.

Process 300 includes selecting (at 308) a set of third-party AI agents from a pool of available third-party AI agents that are relevant to one or more of the first-party controlled interface and the user accessing the first-party controlled interface based on the analyzed (at 304) content of the first-party controlled interface and the tracked (at 306) user activity. For instance, distributed AI provisioning system 100 selects (at 308) the set of third-party AI agents that provide content, services, and/or other offerings that are related to but different from the content, services, and/or other offerings of the first-party controlled interface. Moreover, distributed AI provisioning system 100 selects (at 308) the set of third-party AI agents that provide content, services, and/or other offerings related to the tracked (at 306) user activity.

The selected (at 308) set of third-party AI agents may include AI agents of competitors that provide the same or similar content, services, and/or other offerings from different brands or sources. The selected (at 308) set of third-party AI agents may also include AI agents that provide different complimentary content, services, and/or other offerings to those of the first-party controlled interface. For instance, the first-party controlled interface may provide financial information and the set of third-party AI agents may include a first third-party AI agent of a credit card company, a second third-party AI agent of a bank, and a third third-party AI agent of a lending or debt restructuring company.

Process 300 includes scoring (at 310) a relevance of each third-party AI agent from the set of third-party AI agents to one or more of the user and the first-party controlled interface. In some embodiments, the scoring (at 310) produces a value that is based on the amount of semantic similarity between the content, services, and/or offerings of each third-party AI agent and the user interest and/or the content, services, and/or offering of the first-party controlled interface. In some embodiments, the scoring (at 310) produces a value that is based on the relevance between a classification of the content, services, and/or offerings of each third-party AI agent and the content, services, and/or offerings of the first-party controlled interface. In some embodiments, the scoring (at 310) produces a value that is based on the relevance of the content, services, and/or offerings of each third-party AI agent to the tracked (at 306) user activity.

Process 300 includes initializing (at 312) a real-time bidding platform for the set of third-party AI agents to bid for placement on the first-party controlled interface. Initializing (at 312) the real-time bidding platform may include providing data or statistics about the first-party controlled interface and the user to each entity associated with the set of third-party AI agents.

The data or statistics about the first-party controlled interface may include the average number of visitors the first-party controlled interface receives, the type of content offered by that first-party controlled interface, a referral fee charged by the first-party controlled interface for embedding a third-party AI agent, and/or data about the first-party controlled interface that may assist each third-party entity in valuing the cost for embedding their third-party AI agent on the first-party controlled interface.

The data or statistics about the user may identify specific items or services the user is looking for, demographic information about the user, user interests or preferences, and/or other data about the user that may assist each third-party entity in determining the likelihood of monetizing their content, services, and/or other offerings with that particular user. The data or statistics about the user may be derived from the tracked (at 306) user activity or by uniquely identifying the user and obtaining a user profile containing the user data or statistics.

The real-time bidding platform may be fully automated and may be completed in under one second. Each third-party entity may specify different amounts they are willing to pay to have their third-party AI agent presented on different first-party controlled interfaces and/or for users that meet different criteria. For instance, a third party entity may pay more or bid higher to have their third-party AI agent presented on a luxury goods first-party controlled interface and pay less or bid lower to have their third-party AI agent presented on a discounted goods first-party controlled interface. Similarly, a third party entity may pay more or bid higher to have their third-party AI agent presented on a first-party controlled interface that is accessed by a first type of user (e.g., over 40 years old and living in a big city), and may pay less or bid lower to have third-party AI agent presented on the same first-party controlled interface that is accessed by a second type of user (e.g., under 40 years old and living in a rural location). The bids associated with each third-party AI agent of the selected (at 308) set of third-party AI agents may be predefined and instantly available. In other words, the bids are set prior to initializing (at 312) the real-time bidding platform with each bid being associated with certain criteria for the first-party controlled interface and/or the user that access the first-party controlled interface.

Process 300 includes selecting (at 314) a particular third-party AI agent from the selected (at 310) set of third-party AI agents based on the relevance scoring (at 310) and the results of the initialized (at 312) real-time bidding platform. In some embodiments, the selection (at 314) is based on different weights that are assigned to the relevance score and the associated bid for each third-party AI agent. In some such embodiments, a first third-party AI agent that is less relevant to the first-party controlled interface and/or user will have to place a higher bid than a second third-party AI agent that is more relevant to the first-party controlled interface and/or user in order to be selected (at 314). Accordingly, if two third-party AI agents place the same bid on the real-time bidding platform, distributed AI provisioning system 100 will select (at 314) the third-party AI agent that is determined to be more relevant to the first-party controlled interface and/or user. In some other embodiments, the selection (at 314) is based solely on the highest bid.

The selection (at 314) involves retrieving the container, virtual machine, script, executable binary, or other code associated with the particular third-party AI agent. The selection (at 314) may also include completing a transaction in which the bid amount provided for the selected third-party AI agent is electronically withdrawn from a financial account of the third-party entity that submitted the bid for the selected third-party AI agent, and the bid amount is shared between distributed AI provisioning system 100 and the entity responsible for the first-party controlled interface.

In some embodiments, distributed AI provisioning system 100 may select and display a static advertisement in the event that there are no relevant third-party AI agents available for the first-party controlled interface or in the event that the bids do not satisfy minimum thresholds. In some other embodiments, distributed AI provisioning system 100 may default to an AI agent of the first-party controlled interface in the event that there are no relevant third-party AI agents available for the first-party controlled interface or in the event that the bids do not satisfy minimum thresholds.

Process 300 includes embedding (at 316) the particular third-party AI agent that was selected (at 314) to run as part of the first-party controlled interface. Embedding (at 316) the particular third-party AI agent may include allocating hardware resources to execute the particular third-party AI agent on cloud or edge computing resources 205 or on the same hardware resources that run the first-party controlled interface, and providing a call, link, or other code to integrate or instantiate the particular third-party AI agent within the first-party controlled interface.

Process 300 includes activating (at 318) the particular third-party AI agent to execute within the first-party controlled interface. Activating (at 318) the particular third-party AI agent includes executing the particular third-party AI agent code to create a dialog box, window, or interactive element within the first-party controlled interface through which the user may directly interact with the particular third-party AI agent via textual inputs or verbal commands.

In some embodiments, distributed AI provisioning system 100 may tune or train the third-party AI agents to mirror the style, tone, word usage, and/or visual characteristics of a first-party controlled interface prior to embedding or activating the third-party AI agents on that first-party controlled interface. Distributed AI provisioning system 100 may tune or train the third-party AI agents to provide a more seamless integration of the third-party AI agent on the first-party controlled interface and increase the likelihood that the user engages with the third-party AI agent. The user is less likely to view the tuned and/or trained third-party AI agent as being entirely separate and unrelated to the first-party controlled interface. Rather, the user is likely to view the tuned and/or trained third-party AI agent as an extension or part of the first-party controlled interface.

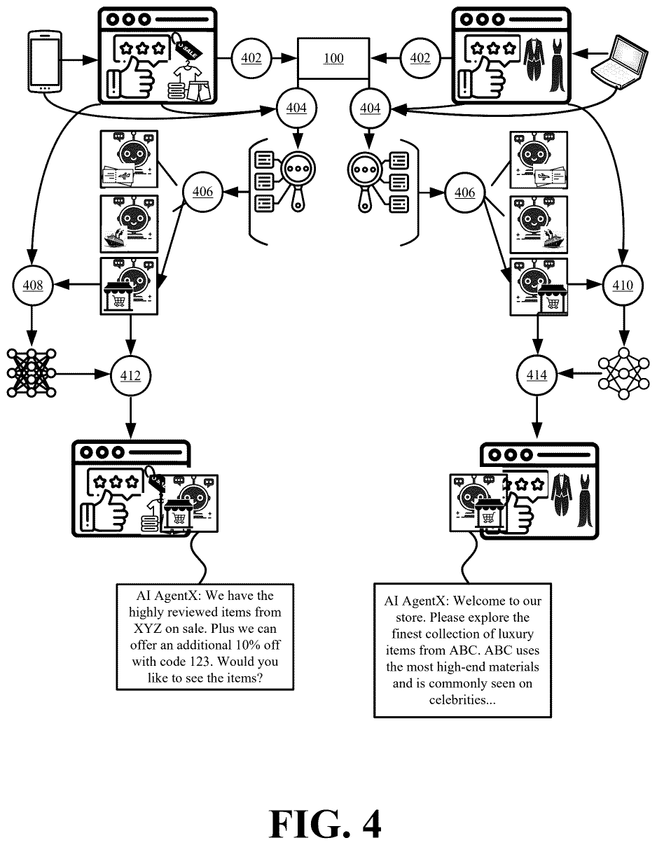

FIG. 4 illustrates an example of training a third-party AI agent for different first-party controlled interfaces in accordance with some embodiments presented herein. Distributed AI provisioning system 100 receives (at 402) requests for a third-party AI agent from two different first-party controlled interfaces.

Distributed AI provisioning system 100 classifies (at 404) each of the two different first-party controlled interfaces and/or the users that access each of the two different first-party controlled interfaces. The classification (at 404) is based on the content, services, and/or offerings that are detected on each of the two different first-party controlled interfaces and based on the preferences or interests of each visiting user, wherein the preferences or interests may be determined based on the users' browsing history and/or interactions with one of the first-party controlled interfaces.

Distributed AI provisioning system 100 selects (at 406) the same third-party AI agent to embed on both first-party controlled interface in response to the selected (at 406) third-party AI agent providing related or pertinent content, services, and/or offerings to each of the first-party controlled interfaces and user interests. In some embodiments, the selection (at 406) is based on the relevance of the third-party AI agent to the first-party controlled interface and/or user classification (at 404). In some embodiments, the selection (at 404) may also be based on the third-party AI agent being associated with the highest bids in the real-time bidding platform for both first-party controlled interfaces.

Distributed AI provisioning system 100 trains (at 408) a first instance of the third-party AI agent based on the content of the first first-party controlled interface and trains (at 410) a second instance of the third-party AI agent based on the content of the second first-party controlled interface. In some embodiments, the third-party AI agents are also trained (at 408 and 410) using the user preferences and/or interests as training data.

The training (at 408) involves adjusting the generative model for the first instance of the third-party AI agent to mirror the style, tone, wording, and/or stylistic characteristics of the first first-party controlled interface. Specifically, the training (at 408) changes the behavior, interactions, and/or outputs of the first instance of the third-party AI agent so that the content, services, or other offerings presented by the third-party AI agent match the style with which the different content, services, or other offerings of the first first-party controlled interface are presented on the first first-party controlled interface. Similarly, the training (at 410) involves adjusting the generative model for the second instance of the third-party AI agent to mirror the style, tone, wording, and/or stylistic characteristics of the second first-party controlled interface.

In some embodiments, the training (at 408 and 410) includes changing the visual characteristics of each third-party AI agent to match the visual characteristics of the first-party controlled interface. Distributed AI provisioning system 100 changes the visual characteristics to more seamlessly integrate the third-party AI agents to the different first-party controlled interface and to give the users the impression that the third-party AI agents are provided by or part of the first-party controlled interface rather than a pop-up that may be considered malware, adware, or untrustworthy because of visual inconsistencies with the first-party controlled interface. Changing the visual characteristics may include changing the graphics, coloring, font (e.g., typography), and/or visual style (e.g., two-dimensional or three-dimensional, rectangular or rounded edges, dark mode or light mode, etc.) of the third-party AI agents to match the graphics, coloring, font, and/or visual style of a first-party controlled interface that is embedded with those third-party AI agents.

Distributed AI provisioning system 100 activates (at 412) the first instance of the third-party AI agent to run on the first first-party controlled interface and activates (at 414) the second instance of the third-party AI agent to run on the second first-party controlled interface. The generative output with which each instance of the third-party AI agent interacts with the users of the respective first-party controlled interfaces is different based on the training. For instance, the first first-party controlled interface is a review site about cheap or discounted goods and the second first-party controlled interface is a review site about high-end or luxury goods. The first instance of the third-party AI agent may immediately identify on-sale, last season, or clearance items of one or more brands or manufacturers reviewed on the first first-party controlled interface or may present coupon or discount codes to entice the user to search for other goods of the one or more brands or manufacturers. The second instance of the third-party AI agent uses a formal greeting to greet the user and extols virtues and advantages of certain high-end or luxury goods of one or more brands or manufacturers reviewed on the second first-party controlled interface.

The advantages to embedding the third-party AI agents on first-party controlled interfaces are new monetization opportunities for the user traffic coming to the first-party controlled interface and the ability to retain the user traffic on the first-party controlled interface rather than have the user navigate to other sites or applications when specific content, services, or offerings are not found directly on the first-party controlled interface. As noted above, the first-party controlled interface may be provided a fee or monetary compensation whenever a third-party AI agent is presented on that first-party controlled interface or when the user completes a transaction using the third-party AI agent that is presented on the first-party controlled interface. Additionally, if the user is retained on the first-party controlled interface when seeking external information through a third-party AI agent, the user has a higher likelihood of returning to the first-party controlled interface once the external information is obtained and then complete a transaction or access services of the first-party controlled interface.

To increase the monetization opportunities and increase the likelihood of retaining user traffic on the first-party controlled interface, distributed AI provisioning system 100 may enable the third-party AI agents to handoff users between different third-party AI agents that are activated on the first-party controlled interface. For instance, distributed AI provisioning system 100 may present a first third-party AI agent on a first-party controlled interface that provides a visiting user with relevant or related content, services, or offerings not provided by the first-party controlled interface. The user may interact with the first third-party AI agent or the first-party controlled interface to indicate that they are seeking other content not provided by either the first third-party AI agent or the first-party controlled interface, and distributed AI provisioning system 100 may terminate the first third-party AI agent and activate a different second third-party AI agent on the first-party controlled interface to provide the other content that the user seeks without the user having to leave the first-party controlled interface. Similarly, the user may interact with the first third-party AI agent and complete a transaction or obtain desired content from the first third-party AI agent. The first third-party AI agent may determine that its objective has been successfully completed and may perform the handoff to a second third-party AI agent where the user may complete transactions for other services or goods or obtain other relevant content that is not offered by either the first third-party AI agent or the first-party controlled interface.

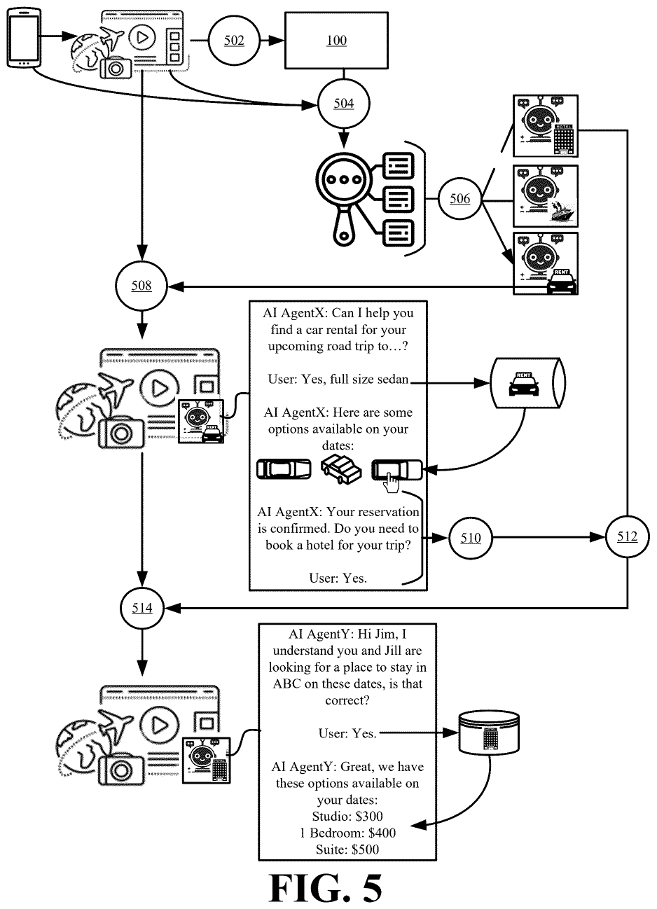

FIG. 5 illustrates an example of performing the third-party AI agent handoff on a first-party controlled interface in accordance with some embodiments presented herein. Distributed AI provisioning system 100 receives (at 502) a request for activation of a third-party AI agent on a first-party controlled interface in response to a new user accessing the first-party controlled interface.

Distributed AI provisioning system 100 analyzes (at 504) the first-party controlled interface context and/or the user activity to select (at 506) a first third-party AI agent that is relevant to the first-party controlled interface and/or user activity. The first third-party AI agent provides content, services, and/or other offerings that differ from those of the first-party controlled interface but that are relevant or complimentary to what is offered on the first-party controlled interface or what the user activity is directed towards.

Distributed AI provisioning system 100 deploys and activates (at 508) the first third-party AI agent on the first-party controlled interface. In some embodiments, distributed AI provisioning system 100 collects a fee from the third-party entity that is responsible for the first third-party AI agent and shares a portion of the fee to the first-party controlled interface.

Distributed AI provisioning system 100 receives (at 510) a handoff request to change from the first third-party AI agent to another third-party AI agent. The handoff request may be issued by the first third-party AI agent in response to user interactions indicating that the user seeks content, services, and/or offerings that are different than those found on the first-party controlled interface or the first third-party AI agent or in response to the first third-party AI agent completing one or more objectives (e.g., completing a transaction with the user).

For example, the first-party controlled interface may be a travel blog and the first third-party AI agent may be provided by a rental car company that offers rental cars in the locations described on the travel blog. The user may interact with the first third-party AI agent to acquire a rental car. The first third-party AI agent may ask the user if they need to book a hotel room for their travels. In response to the user answering affirmatively, the first third-party AI agent may send the handoff request to distributed AI provisioning system 100 with contextual keywords that distributed AI provisioning system 100 may use to select (at 512) a second third-party AI agent.

As another example, the first third-party AI agent may be chatbot for booking flights with a first airline. The user may interact with the first third-party AI agent and specify a destination that the first airline does not travel to or does not have a nonstop flight to the destination from the user's originating airport. Accordingly, the first third-party AI agent may send the handoff request to distributed AI provisioning system 100 with contextual keywords that specify the source and destination airports for the desired nonstop flight. Distributed AI provisioning system 100 may perform a search to identify a second airline that offers the desired nonstop flight, and may select (at 512) a second third-party AI agent of the second airline that the user may interact with to book the flight.

Distributed AI provisioning system 100 embeds and activates (at 514) the second third-party AI agent in place of the first third-party AI agent on the first-party controlled interface. The first third-party AI agent may notify the user of the handoff with an example message such as “I will transfer you to my colleague who can provide the services you are looking for.” In some embodiments, distributed AI provisioning system 100 collects a fee for the handoff and/or activation of the second third-party AI agent. Distributed AI provisioning system 100 may share the fee with the third-party entity responsible for the first third-party AI agent as an incentive for the AI agents to perform the handoffs and improve the customer experience. Distributed AI provisioning system 100 may also share the fee with the first-party controlled interface for originating the user traffic or leads to the different AI agents.

In some embodiments, the shared fee or compensation shared with the first-party controlled interface and/or third-parties whose AI agents perform a handoff may be determined using a wide variety of monetization models beyond traditional click-through or transaction-based methods. The monetization models may include predictive engagement scoring, behavioral analytics, attention modeling, micro-reward systems, off-platform attribution mechanisms, or other outcome-based frameworks that associate user interaction with a quantifiable value. For instance, the fee amount may be based on the activation of a particular interface element or AI agent element, a transaction that is initiated through a particular interface element or AI agent element, time spent by the user interacting with the particular interface element or AI agent element, and/or other engagement tracking on the first-party controlled interface or third-party AI agent that performs the handoff. Distributed AI provisioning system 100 may support such monetization models through logging, user session analysis, real-time auctioning, or value estimation algorithms.

Distributed AI provisioning system 100 may activate (at 514) the second third-party AI agent with the contextual keywords and/or other context that the first third-party AI agent provided with the handoff message. The second third-party AI may use the contextual keywords and/or other context to continue a conversation with the user and/or to pass on acquired user information to avoid the user having to start all over with the second third-party AI agent. For instance, the second third-party AI agent may receive the user's name, location, desired destination, dates or times, number of guests and their information, and/or the content or services that the user is looking for (e.g., a nonstop flight from a source to a destination on specific dates). Accordingly, the second third-party AI agent may engage the user directly at a last conversational state rather than have the user start all over if they were to navigate away from the first-party controlled interface to another site or application.

Additional handoffs between third-party AI agents may occur until the user exits or navigates away from the first-party controlled interface. The user may also close or minimize the activated third-party AI agent if they do not wish to interact with the AI agents.

Example Python code for performing the handoff is provided below:
def handoff_to_next_agent(current_agent_data):
next_agent_url=get_next_agent_url(current_agent_data)
response=requests. post(next_agent_url, json=current_agent_data)
return response. json( )

In some embodiments, distributed AI provisioning system 100 develops machine learning models to improve the selection and/or handoff of the AI agents. In some such embodiments, distributed AI provisioning system 100 models which third-party AI agents have the highest rates of engagement and/or transaction completion for which first-party controlled interfaces, types of first-party controlled interfaces, and/or types of visiting users. Distributed AI provisioning system 100 may use the models to score the relevance of the third-party AI agents for each first-party controlled interface and/or user combination. The relevance modeling provides an improved user experience and/or higher rates of completed transactions which further results in greater monetization for the first-party controlled interface and the third-party AI agents performing the handoffs.

Distributed AI provisioning system 100 and the dynamically selected third-party AI agents may be integrated in first-party controlled interfaces in different ways. In some embodiments, distributed AI provisioning system 100 is integrated into a first-party controlled interface by embedding an advertising tag or other code to run distributed AI provisioning system 100 in the background of the first-party controlled interface. In some other embodiments, distributed AI provisioning system 100 is integrated into a first-party controlled interface as a concierge AI agent.

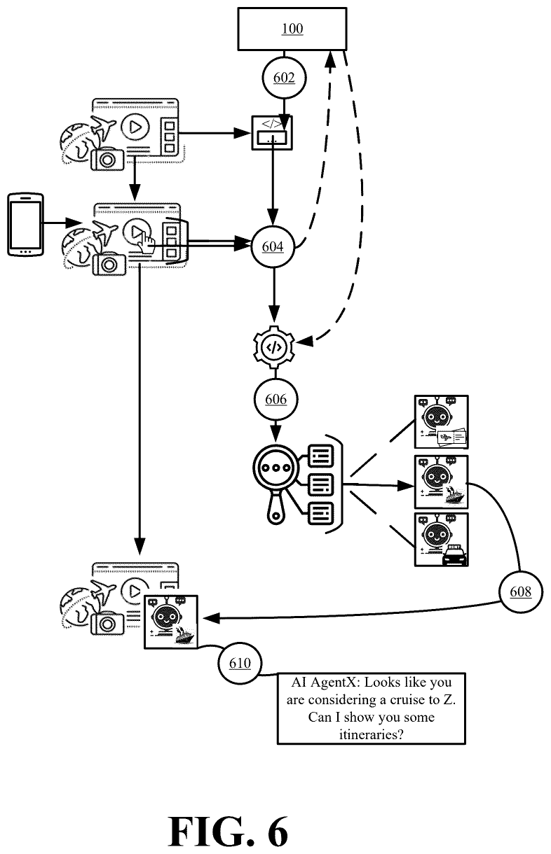

FIG. 6 illustrates an example of distributed AI provisioning system 100 running in the background of a first-party controlled interface in accordance with some embodiments presented herein. A tag or other code for executing controller 207 of distributed AI provisioning system 100 is embedded (at 602) in the code of a first-party controlled interface. Controller 207 may be embedded via traditional ad server integration, tag managers, or direct embedding of the code. The controller 207 code is called or executed when the first-party controlled interface code is called or executed.

The tag or other code initializes one or more services of controller 207 to run locally and/or in the background of the first-party controlled interface. In other words, the initialized services may be dormant in that they do not display a user interface, chatbot, or other element on the first-party controlled interface while running.

In some embodiments, the one or more initialized services of controller 207 include a listening or monitoring service that monitors user context, first-party controlled interface context, chat logs (if accessible), and/or user behaviors. The listening or monitoring service may attach to various Document Object Model (DOM) or application-level events (e.g., page load, scroll, click, chat input, etc.) to monitor the user context and/or user activity.

The listening or monitoring service activates other secondary services when certain triggers (e.g., behavioral, contextual, user-driven, and/or other conditions or events) are met. The secondary services perform the dynamic selection, deployment, embedding, and/or activation of the third-party AI agents with distributed AI provisioning system 100.

The monitored user activity may include user clicks or selections made on the first-party controlled interface, search queries or terms input by the user on the first-party controlled interface, dwell time or tracked time that the user spends viewing different items, scroll depth, hovered over or selected interface elements, redirect links or search query terms that directed the user to the first-party controlled interface, access to the user browsing history, and/or access to other inputs provided by the user. The listening or monitoring service may also scan the content of the first-party controlled interface independent of the user activity.

Certain keywords detected in the user activity or on the first-party controlled interface may trigger the execution of the secondary services for the dynamic selection, deployment, embedding, and/or activation of the third-party AI agents. Similarly, behavioral signals including time on the first-party controlled interface, cart abandonment, interface usage patterns, and the like may trigger the execution of the secondary services.

Upon detecting a triggering event or condition, the listening or monitoring service executes (at 604) the secondary services of controller 207 for the dynamic selection, deployment, embedding, and/or activation of a third-party AI agent on the first-party controlled interface. In some embodiments, the secondary services execute (at 604) locally on the same device (e.g., the user device) that executes the code for the first-party controlled interface. In some other embodiments, the listening or monitoring service issues a request to a remote server of distributed AI provisioning system 100 or calls the functions, API, or code for the secondary services. The called functions, API, or code may be downloaded to run locally as part of the device executing the first-party controlled interface code or may be executed remotely at the remote server.

The listening or monitoring service may supply the secondary services with the monitored user activity and/or scanned content of the first-party controlled interface. The secondary services analyze the data to determine if the data is sufficient to select a third-party AI agent that is relevant to the first-party controlled interface and/or that is of interest to the user. If there is insufficient data, the secondary services delay the selection until more data is sent by the one or more services. If there is sufficient data to make the selection, the secondary services select (at 606) a particular third-party AI agent that is relevant to the first-party controlled interface and/or that is of interest to the user, embeds (at 608) the particular third-party AI agent in the first-party controlled interface, and activates (at 610) the particular third-party AI agent to run as part of the first-party controlled interface.

The particular third-party AI agent may be embedded (at 608) as an SDK that is executed or called from the first-party controlled interface code, as an iFrame that creates a new dialog box, window, or other interactive element in the rendered first-party controlled interface, in a secure sandbox that separates the execution of the particular third-party AI agent code from the first-party controlled interface code. Activating (at 610) the particular third-party AI agent includes generating and presenting an interactive graphical element on the first-party controlled interface with which the user may textually or verbally interact with the particular third-party AI agent.

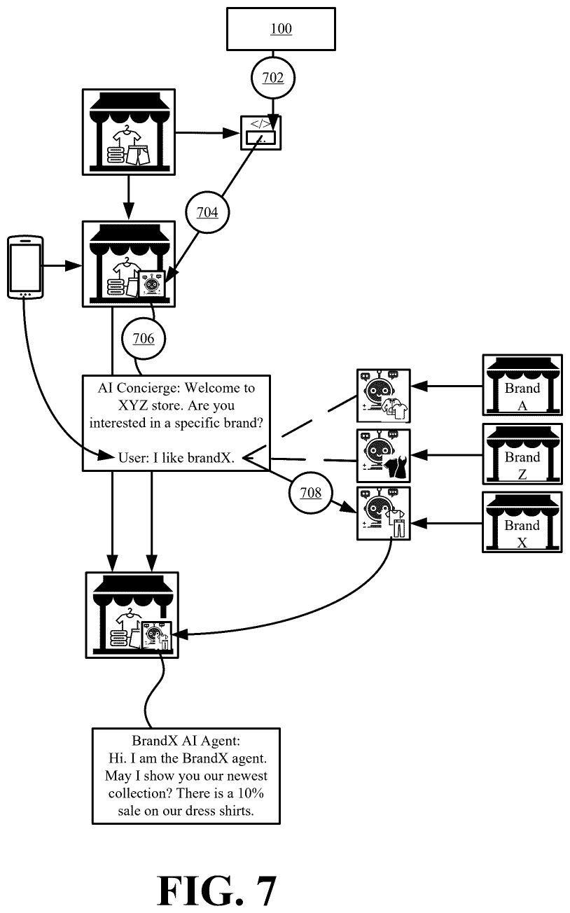

FIG. 7 illustrates an example of integrating distributed AI provisioning system 100 as part of a first-party controlled interface via a concierge AI agent in accordance with some embodiments presented herein. Code for initializing the concierge AI agent is embedded (at 702) into the first-party controlled interface. Accordingly, when the first-party controlled interface is accessed by a user device, the first-party controlled interface is rendered (at 704) with the concierge AI agent running in a separate dialog box, window, iFrame, etc.

The concierge AI agent may engage (at 706) the user with machine-generated questions that are customized based on monitored user activity and/or content of the first-party controlled interface. For instance, the first-party controlled interface may be an online retailer of different goods. The concierge AI agent may ask the user if they are interested in or want to learn more about a specific brand.

Distributed AI provisioning system 100 selects (at 708) a relevant third-party AI agent to replace the concierge AI agent based on the answer that the user gives to the concierge AI agent. For instance, if the user replies with “I like brandX”, distributed AI provisioning system 100 selects (at 708) a third-party AI agent that is created and/or managed by brandX and performs a handoff from the concierge AI agent to the selected (at 708) third-party AI agent. The concierge AI agent may present a message “I will now connect you to the brandX agent”, shut down, and open a new window for the selected (at 708) third-party AI agent. The selected (at 708) third-party AI agent is trained with information about the brandX goods, how to promote the brandX goods, offer specific discounts for the brandX goods, and/or convey benefits or advantages of the brandX goods. The selected (at 708) third-party AI agent connects the user with an AI brandX representative on the site or application of the first-party online retailer, thereby customizing the user experience to the user's interests.

In response to the user inquiring about a different brand (e.g., brandZ), the third-party AI agent of brandX may perform a handoff to another third-party AI agent of brandZ. The third-party AI agent of brandZ is then presented on the first-party controlled interface (e.g., the online retailer site or application), and may interact with the user to present information specific about the brandZ goods that are available on the first-party controlled interface, promote those goods by presented their advantages or offering special discounts, and/or otherwise answer any questions that the user may have about brandZ based on information provided by brandZ.

Distributed AI provisioning system 100 may also run outside of first-party controlled interfaces. For instance, distributed AI provisioning system 100 may be integrated as part of a kiosk that is located in a city, shopping mall, or other destination surrounded by various merchants or service providers.

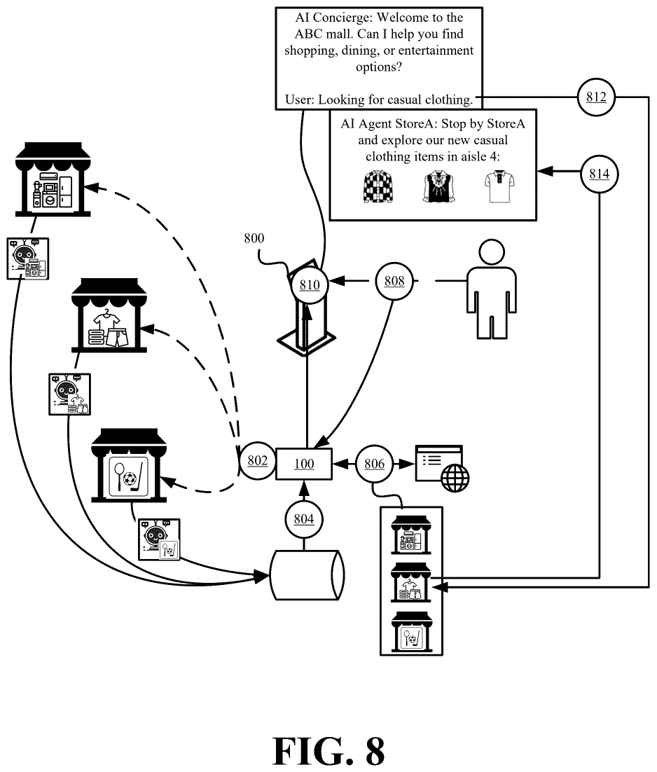

FIG. 8 illustrates an example of integrating distributed AI provisioning system 100 in kiosk 800 in accordance with some embodiments presented herein. Kiosk 800 may include an interactive device with a display for conveying information about nearby businesses. Kiosk 800 may be located indoors or outdoors near the businesses.

Distributed AI provisioning system 100 runs on or as part of kiosk 800. Distributed AI provisioning system 100 detects (at 802) the nearby businesses via geolocation services, a configured location and a mapping service that identifies the nearby businesses, or is configured with a list of the nearby businesses. Distributed AI provisioning system 100 is also configured (at 804) with the third-party AI agents of each nearby business.

Distributed AI provisioning system 100 performs (at 806) a lookup of the nearby businesses. The lookup may include accessing the websites of the businesses to analyze and/or classify their content, services, and/or other offerings. The lookup may also include identifying the third-party AI agent associated with each business.

Distributed AI provisioning system 100 detects (at 808) a user accessing kiosk 800. In some embodiments, kiosk 800 includes a camera, motion sensor, or other sensor to detect the user presence. In some other embodiments, the user is detected after touching or otherwise interacting with kiosk 800.

Distributed AI provisioning system 100 presents (at 810) the concierge AI agent that is customized to assist the user with information about the nearby businesses and/or to assist the nearby businesses with user monetization. Presenting (at 810) the concierge AI agent may include greeting the user and asking the user one or more questions to determine the content or services that the user seeks.

The user may verbally respond, select from a list of options or answers, or may enter their response using a keyboard. Distributed AI provisioning system 100 determines the nearby business that may best assist the user, selects (at 812) the third-party AI agent of that business, and activates (at 814) the selected (at 812) third-party AI agent to run in place of the concierge AI agent on kiosk 800.

The third-party AI agent may display specific goods or services that the business offers that may be of specific interest to the user in order to entice the user to visit the business's physical store. The third-party AI agent may also present promotions or sales that may incentivize the user's visit to the store or may provide information that convinces the user to visit the store.

The third-party AI agent may handoff to another third-party AI agent if the user expresses interest in content, services, or other offerings of another business. In this manner, kiosk 800 may allow the user to scan each of the nearby businesses without having to visit each business and may assist the user in locating specific items without browsing through the store. The third-party AI agent may identify the location of the specific items in the store so that the user may more efficiently find the items they are interested without having to go through aisles or racks of merchandise.

In some embodiments, kiosk 800 via distributed AI provisioning system 100 runs the real-time bidding platform so that businesses offering similar goods or services or that compete for the same users may bid for first interactions with the users. The bidding may be biased based on the relevance of the business content, services, and/or other offerings to the user. For instance, a restaurant AI agent may not be selected and/or presented regardless of the bid amount when the user is searching for a clothing retainer. However, the restaurant with the highest bid may be selected and/or presented on kiosk 800 when the search expresses an interest in nearby dining options. The restaurant's AI agent may present the menu to the user and may promote the restaurant via reviews, presentation of the restaurant chefs, and/or descriptions to entice the user to eat at the restaurant.

In some embodiments, kiosk 800 may be replaced by a user mobile device. For instance, the user mobile device (e.g., a smartphone device) may run an instance of distributed AI provisioning system 100. The running instance may detect the nearby businesses using geolocation services that identify the mobile device location and online searches of businesses in the area. The user mobile device may present the concierge AI agent and the concierge AI agent may select and activate a third-party AI agent of a nearby business that is of interest to the user.

Distributed AI provisioning system 100 may be used to power a next generation search engine. Rather than present links to websites or applications that are relevant to a user query, the next generation search engine may directly connect a user to different third-party AI agents that are relevant to the user query.

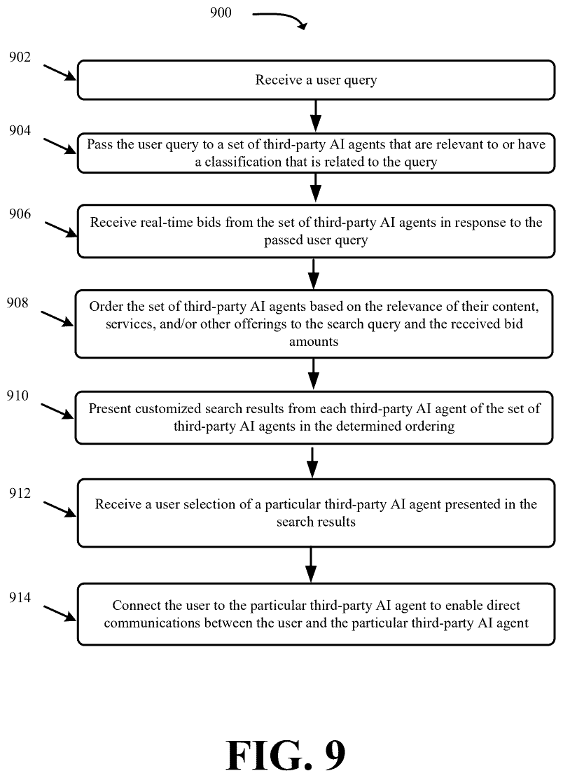

FIG. 9 presents a process 900 for providing third-party AI agents as search results to a user query in accordance with some embodiments presented herein. Process 900 is implemented by distributed AI provisioning system 100.

Process 900 includes receiving (at 902) a user query. For instance, the user query may request “Find the best laptop for graphic design under $800”. The user query may be submitted via a search engine interface as text or as an audible prompt.

Process 900 includes passing (at 904) the user query to a set of third-party AI agents that are relevant to or have a classification that is related to the query. For instance, the laptop query may be passed from distributed AI provisioning system 100 to third-party AI agents of different computer retailers.

Process 900 includes receiving (at 906) real-time bids on a real-time bidding platform from the set of third-party AI agents in response to the passed (at 904) user query. The real-time bids may be based on the relevance of goods and services that each third-party AI agent offers to the user query and a confidence score that each third-party AI agent derives for the likelihood that the offered goods and services will result in a completed transaction with the user. For instance, a first third-party AI agent may determine that it has laptops under $800 but that the laptops include low-power graphics processors and a second third-party AI agent may determine that is has laptops under $800 with high-power graphics processors. Accordingly, the second third-party AI agent may bid higher than the first third-party AI agent on the real-time bidding platform in order for distributed AI provisioning system 100 to present the second third-party AI agent over the first third-party AI agent in the search results.

Process 900 includes ordering (at 908) the set of third-party AI agents based on the relevance of their content, services, and/or other offerings to the search query and the bid amounts received (at 906) via the real-time bidding platform. The third-party AI agents offering the most relevant content or services to the search query and with the highest bids are ordered first.

Process 900 includes presenting (at 910) customized search results from each third-party AI agent of the set of third-party AI agents in the determined ordering (at 908). The customized search results differ from typical search engine results. Typical search engine results provide a clickable link to a website or application with a short description of the relevant content, services, or other offerings from that website or application. The customized search results include content that each third-party AI agent dynamically generates in response to the user query to persuade the user to connect with that third-party AI agent. For instance, a search engine result may state “Our laptop model XYZ has the latest generation graphics processor while staying below your $800 budget. Staying under budget shouldn't mean sacrificing performance.”

Process 900 includes receiving (at 912) a user selection of a particular third-party AI agent presented in the search results. Process 900 includes connecting (at 914) the user to the particular third-party AI agent to enable direct communications between the user and the particular third-party AI agent. Rather than present the same website or application to users that click on a search result link, the particular third-party AI agent starts a conversation with the user to filter and present customized content, services, or offerings that are of most interest to the user.

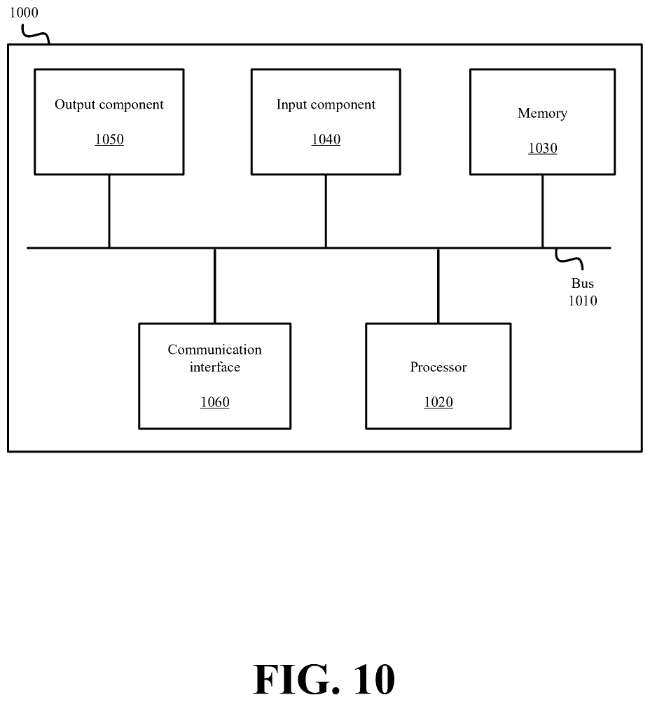

FIG. 10 is a diagram of example components of device 1000. Device 1000 may be used to implement one or more of the tools, devices, or systems described above (e.g., distributed AI provisioning system 100, controller 207, etc.). Device 1000 may include bus 1010, processor 1020, memory 1030, input component 1040, output component 1050, and communication interface 1060. In another implementation, device 1000 may include additional, fewer, different, or differently arranged components.

Bus 1010 may include one or more communication paths that permit communication among the components of device 1000. Processor 1020 may include a processor, microprocessor, or processing logic that may interpret and execute instructions. Memory 1030 may include any type of dynamic storage device that may store information and instructions for execution by processor 1020, and/or any type of non-volatile storage device that may store information for use by processor 1020.

Input component 1040 may include a mechanism that permits an operator to input information to device 1000, such as a keyboard, a keypad, a button, a switch, etc. Output component 1050 may include a mechanism that outputs information to the operator, such as a display, a speaker, one or more LEDs, etc.

Communication interface 1060 may include any transceiver-like mechanism that enables device 1000 to communicate with other devices and/or systems. For example, communication interface 1060 may include an Ethernet interface, an optical interface, a coaxial interface, or the like. Communication interface 1060 may include a wireless communication device, such as an infrared (IR) receiver, a Bluetooth® radio, or the like. The wireless communication device may be coupled to an external device, such as a remote control, a wireless keyboard, a mobile telephone, etc. In some embodiments, device 1000 may include more than one communication interface 1060. For instance, device 1000 may include an optical interface and an Ethernet interface.

Device 1000 may perform certain operations relating to one or more processes described above. Device 1000 may perform these operations in response to processor 1020 executing software instructions stored in a computer-readable medium, such as memory 1030. A computer-readable medium may be defined as a non-transitory memory device. A memory device may include space within a single physical memory device or spread across multiple physical memory devices. The software instructions may be read into memory 1030 from another computer-readable medium or from another device. The software instructions stored in memory 1030 may cause processor 1020 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

The actual software code or specialized control hardware used to implement an embodiment is not limiting of the embodiment. Thus, the operation and behavior of the embodiment has been described without reference to the specific software code, it being understood that software and control hardware may be designed based on the description herein.

For example, while series of messages, blocks, and/or signals have been described with regard to some of the above figures, the order of the messages, blocks, and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, while some devices are shown as communicating with a network, some such devices may be incorporated, in whole or in part, as a part of the network.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well-known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Some implementations described herein may be described in conjunction with thresholds. The term “greater than” (or similar terms), as used herein to describe a relationship of a value to a threshold, may be used interchangeably with the term “greater than or equal to” (or similar terms). Similarly, the term “less than” (or similar terms), as used herein to describe a relationship of a value to a threshold, may be used interchangeably with the term “less than or equal to” (or similar terms). As used herein, “exceeding” a threshold (or similar terms) may be used interchangeably with “being greater than a threshold,” “being greater than or equal to a threshold,” “being less than a threshold,” “being less than or equal to a threshold,” or other similar terms, depending on the context in which the threshold is used.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

1. A method comprising:
receiving a request that indicates a user accessing a first-party controlled interface;
selecting a particular third-party artificial intelligence (AI) agent from a plurality of third-party AI agents based on the particular third-party AI agent being associated with content, services, or offerings that are different from and related to content, services, or offerings on the first-party controlled interface;
embedding the particular third-party AI agent on the first-party controlled interface; and
activating the particular third-party AI agent to execute as part of the first-party controlled interface, wherein activating the particular third-party AI agent comprises:
presenting an interactive interface on the first-party controlled interface, wherein the interactive interface is independent of the first-party controlled interface; and
generating, by execution of the particular third-party AI agent on the first-party controlled interface, content in the interactive interface that is dynamically customized based on the different but related content, services, or offerings and user interactions with one or more of the interactive interface and the first-party controlled interface.

2. The method of claim 1 further comprising:
analyzing the content, services, or offerings of the first-party controlled interface;
selecting a set of third-party AI agents from the plurality of third-party AI agents that are associated with content, services, or offerings that are related to but different from the content, services, or offerings on the first-party controlled interface;
tracking user activity that is performed on the first-party controlled interface; and
wherein selecting the particular third-party AI agent comprises determining that the different but related content, services, or offerings associated with the particular third-party AI agent are of greater relevance to the user activity than the content, services, or offerings of other third-party AI agents in the set of third-party AI agents.

3. The method of claim 1 further comprising:
modifying code of the first-party controlled interface to include a listening service that triggers deployment of a third-party AI agent on the first-party controlled interface in response to detecting one or more events occurring on the first-party controlled interface.

4. The method of claim 1, wherein embedding the particular third-party AI agent comprises:
generating an iFrame or a new window that presents the interactive interface for the particular third-party AI agent over a region of the first-party controlled interface.

5. The method of claim 1 further comprising:
generating a real-time bidding platform in response to the request;
receiving different bids for placing each of the plurality of third-party AI agents on the first-party controlled interface via the real-time bidding platform; and
wherein selecting the particular third-party AI agent comprises determining that a bid placed for the particular third-party AI agent is greater than the different bids placed for other third-party AI agents of the plurality of third-party AI agents.

6. The method of claim 5, wherein receiving the different bids comprises:
retrieving a specific bid from a plurality of different bids that are previously defined for each of the plurality of third-party AI agents and for a classification of the first-party controlled interface.

7. The method of claim 5, wherein each bid is weighted based on real-time user interactions or behavioral patterns with the first-party controlled interface.

8. The method of claim 1 further comprising:
receiving a user input in the interactive interface;
determining that the user input is directed to content, services, or offerings that are different than the related content, services, or offerings associated with the particular third-party AI agent; and
performing a handoff within the first-party controlled interface from the particular third-party AI agent to a second third-party AI agent that is associated with content, services, or offerings specified in the user input.

9. The method of claim 8, wherein performing the handoff comprises:
removing the interactive interface of the particular third-party AI agent from the first-party controlled interface; and
providing a new interface for the second third-party AI agent on the first-party controlled interface.

10. The method of claim 8, wherein performing the handoff comprises:
removing the particular third-party AI agent from the first-party controlled interface;
embedding the second third-party AI agent on the first-party controlled interface; and
activating the second third-party AI agent to execute as part of the first-party controlled interface.

11. The method of claim 8, wherein performing the handoff comprises:
transferring contextual session data or user preferences to the second third-party AI agent, wherein the contextual session data or user preferences maintain continuity of interaction from the particular third-party AI agent to the second third-party AI agent.

12. The method of claim 1 further comprising:
analyzing the first-party controlled interface;
determining one or more of a style, tone, and wording of the first-party controlled interface based on said analyzing;
training the particular third-party AI agent with the one or more of the style, tone, and wording of the first-party controlled interface; and
adapting the dynamic content that is generated in the interactive interface to mirror the one or more of the style, tone, and wording of the first-party controlled interface in response to said training.

13. The method of claim 1 further comprising:
adapting a visual appearance of the particular third-party AI agent to match one or more design elements of the first-party controlled interface, wherein the one or more design elements comprise layout, color scheme, font, or visual style.

14. A system comprising:
a controller comprising one or more hardware processors configured to:
receive a request that indicates a user accessing a first-party controlled interface;
select a particular third-party artificial intelligence (AI) agent from a plurality of third-party AI agents based on the particular third-party AI agent being associated with content, services, or offerings that are different from and related to content, services, or offerings on the first-party controlled interface;
embed the particular third-party AI agent on the first-party controlled interface; and
activate the particular third-party AI agent to execute as part of the first-party controlled interface, wherein activating the particular third-party AI agent comprises:
presenting an interactive interface on the first-party controlled interface, wherein the interactive interface is independent of the first-party controlled interface; and
generating, by execution of the particular third-party AI agent on the first-party controlled interface, content in the interactive interface that is dynamically customized based on the different but related content, services, or offerings and user interactions with one or more of the interactive interface and the first-party controlled interface.

15. The system of claim 14, wherein the one or more hardware processors are further configured to:
analyze the content, services, or offerings of the first-party controlled interface;
select a set of third-party AI agents from the plurality of third-party AI agents that are associated with content, services, or offerings that are related to but different from the content, services, or offerings on the first-party controlled interface;
track user activity that is performed on the first-party controlled interface; and
wherein selecting the particular third-party AI agent comprises determining that the different but related content, services, or offerings associated with the particular third-party AI agent are of greater relevance to the user activity than the content, services, or offerings of other third-party AI agents in the set of third-party AI agents.

16. The system of claim 14, wherein the one or more hardware processors are further configured to:
modify code of the first-party controlled interface to include a listening service that triggers deployment of a third-party AI agent on the first-party controlled interface in response to detecting one or more events occurring on the first-party controlled interface.

17. The system of claim 14, wherein embedding the particular third-party AI agent comprises:
generating an iFrame or a new window that presents the interactive interface for the particular third-party AI agent over a region of the first-party controlled interface.

18. The system of claim 14, wherein the one or more hardware processors are further configured to:
generate a real-time bidding platform in response to the request;
receive different bids for placing each of the plurality of third-party AI agents on the first-party controlled interface via the real-time bidding platform; and
wherein selecting the particular third-party AI agent comprises determining that a bid placed for the particular third-party AI agent is greater than the different bids placed for other third-party AI agents of the plurality of third-party AI agents.

19. The system of claim 18, wherein receiving the different bids comprises:
retrieving a specific bid from a plurality of different bids that are previously defined for each of the plurality of third-party AI agents and for a classification of the first-party controlled interface.

20. A non-transitory computer-readable medium storing instructions that, when executed by one or more processors of a distributed artificial intelligence (AI) provisioning system, cause the distributed AI provisioning system to perform operations comprising:
receiving a request that indicates a user accessing a first-party controlled interface;
selecting a particular third-party AI agent from a plurality of third-party AI agents based on the particular third-party AI agent being associated with content, services, or offerings that are different from and related to content, services, or offerings on the first-party controlled interface;
embedding the particular third-party AI agent on the first-party controlled interface; and
activating the particular third-party AI agent to execute as part of the first-party controlled interface, wherein activating the particular third-party AI agent comprises:
presenting an interactive interface on the first-party controlled interface, wherein the interactive interface is independent of the first-party controlled interface; and
generating, by execution of the particular third-party AI agent on the first-party controlled interface, content in the interactive interface that is dynamically customized based on the different but related content, services, or offerings and user interactions with one or more of the interactive interface and the first-party controlled interface.
